(19) United States
(12) Patent Application Publication
(10) Pub. No.: US 2026/0160158 A1
(43) Pub. Date: Jun. 11, 2026

(54) METHOD AND SYSTEM FOR OPTIMIZED WELL PLACEMENT IN A GEOGRAPHIC REGION

(71) Applicant: Enverus, Inc., Austin, TX (US)

(72) Inventors: Boyuan Zhou, Calgary (CA); Sam Dawson, Austin, TX (US); Curtis Hess, Calgary (CA); Cayley Krynowsky, Calgary (CA); Abbie Rolf von den Baumen, Calgary (CA); David Howard, Calgary (CA); Manuj Nikhanj, Calgary (CA); Livan B. Alonso, Bryn Mawr, PA (US)

(73) Assignee: Enverus, Inc., Austin, TX (US)

(21) Appl. No.: 19/180,534

(22) Filed: Apr. 16, 2025

Related U.S. Application Data
(60) Provisional application No. 63/634,956, filed on Apr. 17, 2024.

(51) Int. Cl. E21B 43/30

(52) U.S. Cl. CPC E21B 43/30; E21B 2200/20

(57) ABSTRACT

A computing system receives a request to place new wells in a geographic area comprising pre-existing wells. The computing system identifies an open region in the geographic area for placement of the new wells. The computing system determines an angle at which to place the new wells in the open region based on a subset of the pre-existing wells in the open region. The computing system defines boundaries of the open region for placement of the new wells. The computing system places at least one new well within the boundaries of the open region in accordance with the constraints. The computing system generates a graphical representation of the geographic area with the pre-existing wells and the at least one new well in the boundaries of the open region.

### FIELD OF DISCLOSURE

The present disclosure generally relates to the field of well placement optimization within a geographic region, and more specifically, to systems and methods for determining the placement of new wells based on spatial analysis and geometric considerations.

### BACKGROUND

In the ever-evolving field of oil and gas exploration, the strategic placement of wells within a geographic region is a task of paramount concern. The industry has seen a continuous drive towards innovation, with the aim of maximizing the extraction of resources while minimizing the environmental impact. This has led to the development of sophisticated techniques and systems that leverage spatial analysis and geometric considerations to optimize well placement.

### SUMMARY

In some embodiments, a method of placing infill wells in a geographic area that includes pre-existing wells is disclosed herein. A computing system receives a request to place new wells in a geographic area that includes pre-existing wells. The request includes constraints for the new wells. The constraints include size information of the new wells and spacing information for the new wells. The computing system identifies an open region in the geographic area for placement of the new wells. The computing system determines an angle at which to place the new wells in the open region based on a subset of the pre-existing wells in the open region. The computing system defines boundaries of the open region for placement of the new wells. The computing system places at least one new well within the boundaries of the open region in accordance with the constraints. The computing system generates a graphical representation of the geographic area with the pre-existing wells and the at least one new well in the boundaries of the open region.

In some embodiments, a non-transitory computer readable medium is disclosed herein. The non-transitory computer readable medium includes one or more sequences of instructions, which, when executed by a processor, causes a computing system to perform operations. The operations include receiving, by a computing system, a request to place new wells in a geographic area comprising pre-existing wells. The request includes constraints for the new wells. The constraints include size information of the new wells and spacing information for the new wells. The operations further include identifying, by the computing system, an open region in the geographic area for placement of the new wells. The operations further include determining, by the computing system, an angle at which to place the new wells in the open region based on a subset of the pre-existing wells in the open region. The operations further include defining, by the computing system, boundaries of the open region for placement of the new wells. The operations further include placing, by the computing system, at least one new well within the boundaries of the open region in accordance with the constraints. The operations further include generating, by the computing system, a graphical representation of the geographic area with the pre-existing wells and the at least one new well in the boundaries of the open region.

In some embodiments, a system is disclosed herein. The system includes a processor and a memory. The memory has programming instructions stored thereon, which, when executed by the processor, causes the system to perform operations. The operations include receiving a request to place new wells in a geographic area comprising pre-existing wells. The request includes constraints for the new wells. The constraints include size information of the new wells and spacing information for the new wells. The operations further include identifying an open region in the geographic area for placement of the new wells. The operations further include determining an angle at which to place the new wells in the open region based on a subset of the pre-existing wells in the open region. The operations further include defining boundaries of the open region for placement of the new wells. The operations further include placing at least one new well within the boundaries of the open region in accordance with the constraints. The operations further include generating a graphical representation of the geographic area with the pre-existing wells and the at least one new well in the boundaries of the open region.

### BRIEF DESCRIPTION OF FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 is a schematic representation of a geographical area, according to example embodiments.

FIG. 3 is a schematic representation of a geographical area, according to example embodiments.

FIG. 4 is a schematic representation of a geographical area, according to example embodiments.

FIG. 5 is a schematic representation of a geographical area, according to example embodiments.

FIG. 6 is a schematic representation of a geographical area, according to example embodiments.

FIG. 7 is a flow diagram illustrating a method for placing wells in a geographic area, according to example embodiments.

FIG. 8 is a flow diagram illustrating a method for placing wells in a geographic area, according to example embodiments.

FIG. 9A is a block diagram illustrating a computing device, according to example embodiments of the present disclosure.

FIG. 9B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure generally relates to systems and methods for optimizing the placement of wells within a geographic region. More specifically, the disclosure may provide techniques for analyzing a geographic area, identifying potential locations for new wells, and determining the placement of these wells in a manner that maximizes coverage and minimizes disruption to existing wells. Such approach improves upon conventional techniques for placing new wells within a geographic area. For example, traditionally, such process required the use of geographic information system (GIS) software, such as ArcGIS. Such a process was labor intensive and inconsistent due to the highly manual nature of interacting with such software. The present approach improves upon conventional techniques by removing the human element from the analysis and improving efficiency, thus resulting in the highly precise placement of wells in a geographic region.

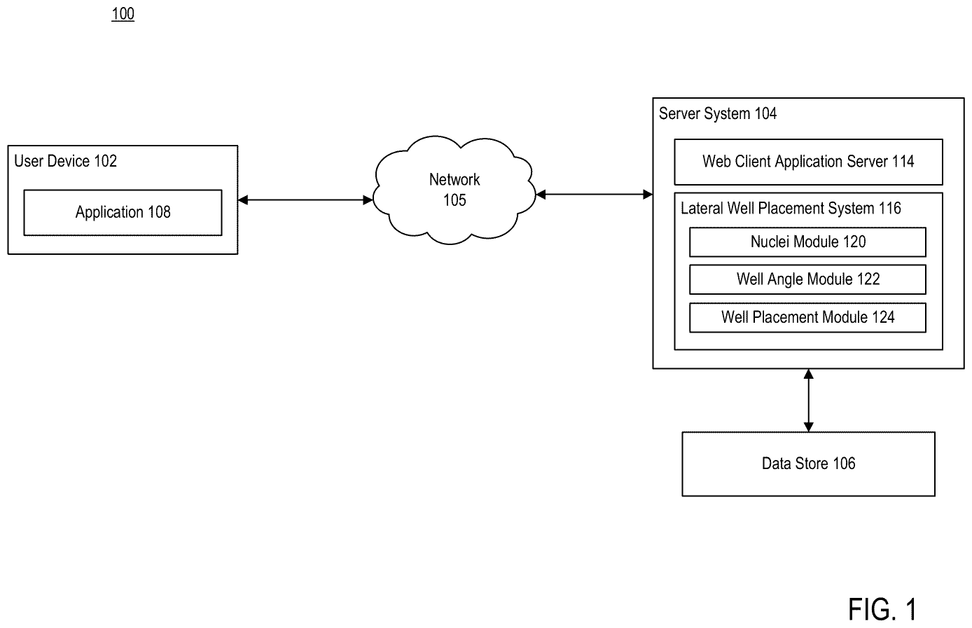

FIG. 1 is a block diagram illustrating a computing environment 100, according to example embodiments. Computing environment 100 may include a user device 102 and a server system 104 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user. For example, user device 102 may be associated with a user or subscriber associated with server system 104. In some embodiments, user device 102 may be representative of a mobile device, a tablet, a desktop computer, or any computing system having capabilities described herein. User device 102 may include an application 108 executing thereon. Application 108 may be representative of an application associated with server system 104. In some embodiments, application 108 may be a standalone application associated with server system 104, such as a mobile application, tablet application, or, more generally, a software application affiliated with an entity associated with server system 104. In some embodiments, application 108 may be representative of a web browser configured to communicate with server system 104. More generally, application 108 may be configured to provide an interface between user device 102 and server system 104 for the purpose of a user providing inputs to server system 104 for server system 104 to generate infill wells for a target geographic region based on constraints provided by user device 102.

Server system 104 may include web client application server 114 and lateral well placement system 116. In some embodiments, web client application server 114 may be representative of a software component configured to handle requests from the user device 102 and to communicate those requests to lateral well placement system 116. Lateral well placement system 116 may be configured to generate lateral wells for infill drilling in a geographic area of interest. Lateral well placement system 116 may include nuclei module 120, well angle module 122, and well placement module 124. Each of nuclei module 120, well angle module 122, and well placement module 124 may be comprised of one or more software modules. The one or more software modules are collections of code or instructions stored on a media (e.g., memory of server system 104) that represent a series of machine instructions (e.g., program code) that implements one or more algorithmic steps. Such machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Nuclei module 120 may be configured to identify open regions in a geographic area of interest for potentially placing lateral wells. In some embodiments, nuclei module 120 may identify open regions within a geographic area through a triangularization process, in which a plurality of nuclei or points in the geographic area are identified. In some embodiments, nuclei module 120 may employ a Delauney triangularization algorithm to generate a plurality of triangles in the geographic area. For example, nuclei module 120 may identify a plurality of vertices in the geographic area. The plurality of vertices in the geographic area may be based on existing wells or geometric objects in the geographic area. Nuclei module 120 may then use these vertices to create a plurality of triangles using a triangularization algorithm. From these triangles, nuclei module 120 may then take the midpoint of each side of each triangle. These midpoints may then represent the nuclei or points for further analysis.

In order to determine which nuclei or points to use, nuclei module 120 may rank the plurality of nuclei based on the distance of each nucleus to the nearest geometric object or existing well. In some embodiments, nuclei module 120 may take the Euclidean distance between each nucleus and the nearest geometric object. Nuclei module 120 may rank each nucleus, with the highest-ranking nuclei representing that nucleus having the greatest distance from any geometric object or existing well in the geographic area. Nuclei module 120 may select the highest ranked nuclei as the first nucleus for analysis.

In some embodiments, such as when the geographic area of interest includes drilling spacing units (DSUs), nuclei module 120 may perform this analysis on a DSU-by-DSU basis. For example, rather than implement the triangularization process on the entire geographic region at once, nuclei module 120 may perform the triangularization process within each DSU. Once wells are placed or determined for a given DSU, nuclei module 120 may restart the process for a second DSU until all DSUs have been analyzed.

Once the nucleus is selected, well angle module 122 may be configured to determine an angle at which a new well will be placed. In some embodiments, well angle module 122 may be configured to determine the angle at which the place a new well in order to match the angle of the new well to existing wells in a geographic region surrounding the selected nucleus. In some embodiments, well angle module 122 may identify an angle of existing wells in the geographic region surrounding the selected nucleus by taking a minimum rotated rectangle of geographic objects or existing wells in a region including the selected nucleus. In some embodiments, the number of existing wells in a region including the selected nucleus may be limited to five or fewer. In some embodiments, the number of existing wells in a region including the selected nucleus may include five or more existing wells. As those skilled in the art understand, the size or the minimum rotated rectangle (i.e., the amount of geographic objects or existing wells encompassed by the minimum rotated rectangle) may be user defined. Once the rectangle is generated, well angle module 122 may determine the angle of placement by taking the angle of the longer side of the rectangle.

In some embodiments, such as when DSUs are taken into consideration, well angle module 122 may determine the angle of placement by taking a minimum rotated rectangle of the DSU. For example, well angle module 122 may generate a minimum rotated rectangle that fits the boundaries of the DSU. Similarly, well angle module 122 may determine the angle of placement by taking the angle of the longer side of the rectangle.

Well placement module 124 may be configured to place a well based on the selected nucleus and determined angle of placement. For example, well placement module 124 may place a minimum length at the selected nucleus at the determined angle. In some embodiments, the selected nucleus may act as a midpoint of the minimum length well. In some embodiments, the minimum length may be defined by the user or operator. For example, an operator may request that wells be placed between 3000 feet and 10000 feet in length. In this example, a minimum sized well may be a 3000 foot well. Once the well is placed, well placement module 124 may then buffer out the well based on spacing constraints defined by the user. For example, a user or operator may request that wells be spaced 800 feet apart. As such, well placement module 124 may buffer out the well based on the 800-foot spacing constraint. In some embodiments, buffering out the well may include spacing the well on each side of the well. Continuing with the current example, buffering a well based on an 800-foot spacing constraint may yield a minimum length well that is spaced 400 feet on both sides (e.g., 800-foot spacing constraint/2). In some embodiments, existing wells may also be buffered in accordance with the spacing constraint.

Once the minimum length, minimum spaced well is generated and placed, well placement module 124 may build out a region surrounding the minimum length, minimum spaced well for the inclusion of multiple wells. For example, well placement module 124 may expand the minimum length, minimum spaced well width wise until the spacing parameters are violated by any existing wells or other geographic object. In some embodiments this may be done by expanding the minimum length, minimum spaced well in a direction perpendicular to the placement angle. Following expansion in the width direction, well placement module 124 may then expand a length of the minimum length, minimum spaced well. In some embodiments, this may be done by expanding the now expanded minimum length, minimum spaced well in a direction parallel with the placement angle. Once the region is defined in the length and width directions, well placement module 124 may determine a number of wells that can be placed in the region in accordance with the constraints defined by the user or operator.

In some embodiments, once the wells are placed in the region, lateral well placement system 116 may restart the process by identifying a next highest ranked nuclei for the geographic area. In some embodiments, nuclei module 120 may identify the next highest ranked nuclei by removing from the list all nuclei that were included in the region filled by wells by well placement module 124. Such process may continue until no nuclei are left.

In some embodiments, lateral well placement system 116 may be configured to re-execute the process by identifying the potential for wells to be placed perpendicular to the angle of existing wells. Through this process, lateral well placement system 116 may attempt to optimize any open space within the geographic area defined by the user.

In this manner, lateral well placement system 116 may be configured to optimize the placement of new wells in a geographical area. Lateral well placement system 116 provides a flexible and adaptable approach to well placement, allowing for adjustments based on user-defined parameters and the specific characteristics of the geographic region.

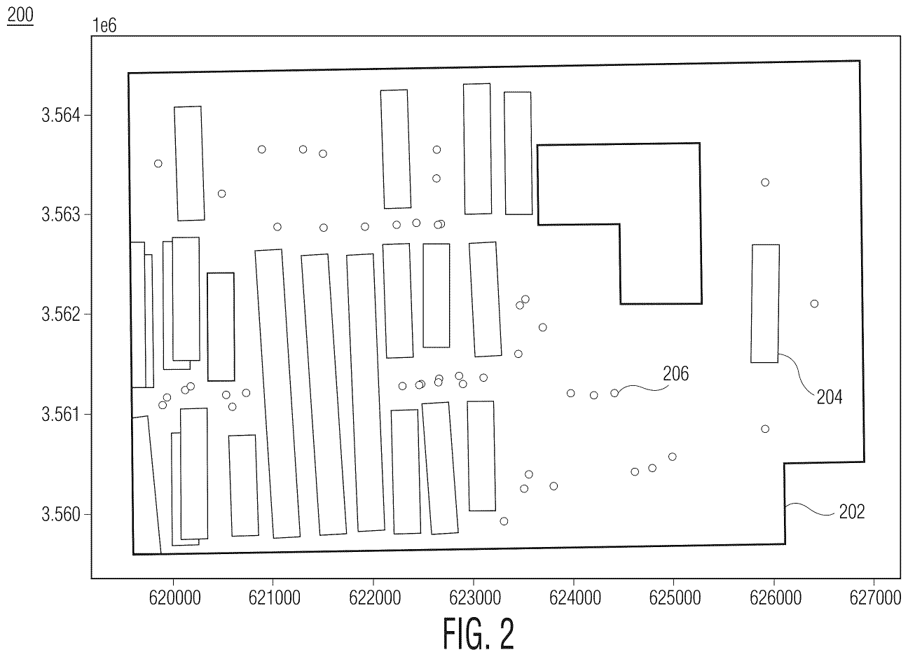

FIG. 2 is a schematic representation 200 of a geographical area 202, according to example embodiments. As shown, geographical area 202 may include a plurality of existing wells 204. For ease of discussion, each existing well shown across FIGS. 2-6 may be represented with a diagonal fill pattern; additionally, existing geometric objects may be represented with a horizontal fill pattern. In some embodiments, lateral well placement system 116 may identify existing well information from data store 106 or one or more third party systems. Further, schematic representation 200 may include a plurality of nuclei 206. Each nucleus 206 may be generated using a triangularization process. Each nucleus 206 is shown in an open region of geographical area 202.

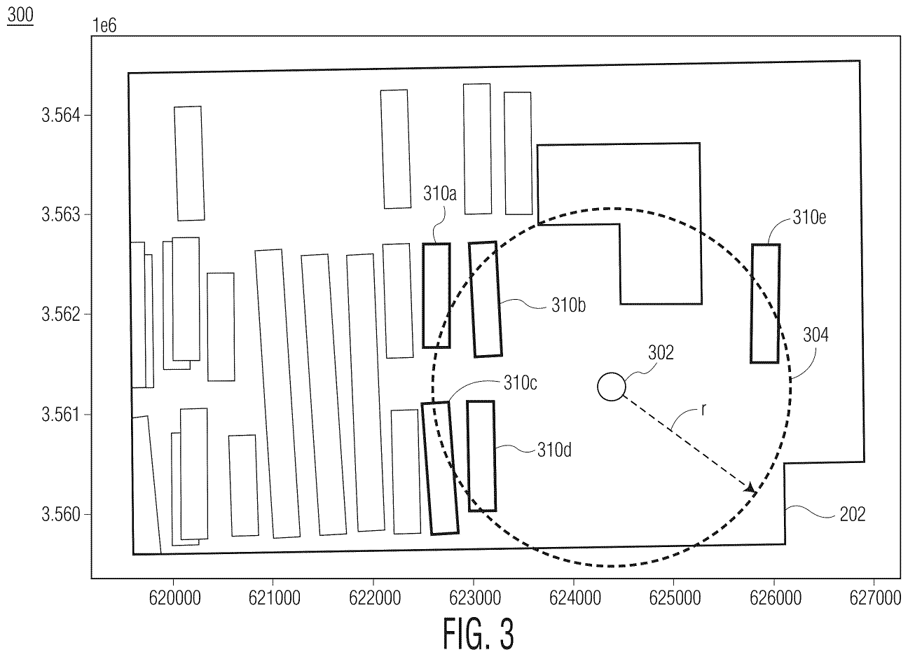

FIG. 3 is a schematic representation 300 of geographical area 202, according to example embodiments. As shown, nuclei module 120 has identified nucleus 302 as being the highest ranked nucleus of beginning the analysis. For example, nuclei module 120 determined that nucleus 302 has the farthest distance from any existing well or geometric object. Schematic representation 300 may include circle 304, which may have been generated by well angle module 122. Circle 304 is defined by a radius r. In some embodiments, radius r may be set by a user or operator associated with user device 102 or an individual associated with server system 104. Circle 304 may assist well angle module 122 in identifying a subset of existing wells for determining an angle of placement. For example, as shown, well angle module 122 may identify existing wells 310a, 310b, 310c, 310d, and 310e for matching. As such, when well angle module 122 attempts to identify an angle of placement for a new well, well angle module 122 may leverage the angles of existing wells 310a-310e. For example, well angle module 122 may generate a minimum rotated rectangle based on existing wells 310a-310e.

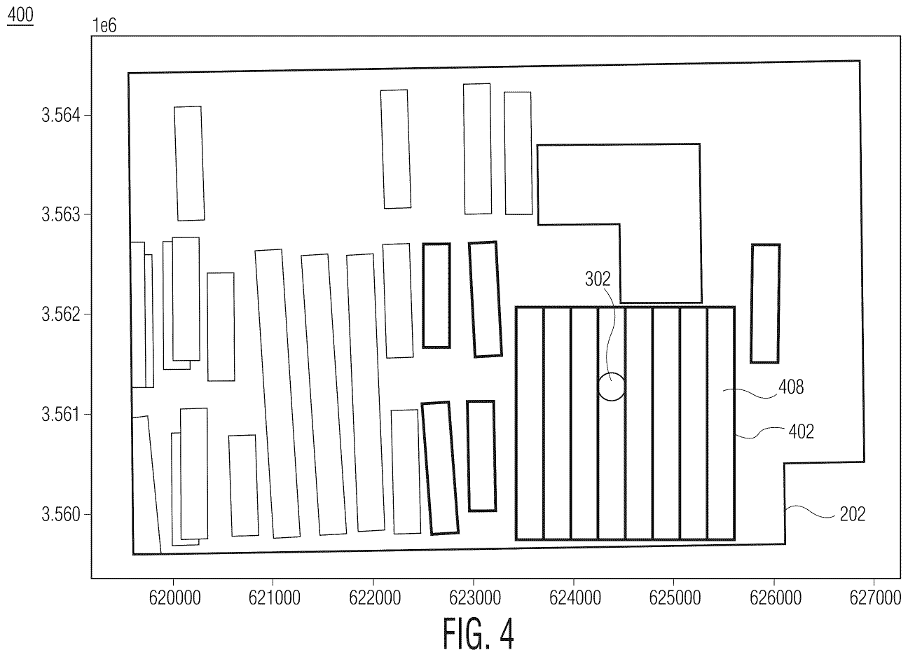

FIG. 4 is a schematic representation 400 of geographical area 202, according to example embodiments. As shown, based on selected nucleus 302 and the determined angle of placement, well placement module 124 may have placed a minimum sized, minimum spaced well 408. Using this minimum sized, minimum spaced well as a starting point, well placement module 124 may define a region 402 by expanding the minimum sized, minimum spaced well in the width direction (e.g., perpendicular to the placement angle) and then the length direction. Each individual rectangle may correspond to a buffered well 308 placed in region 402.

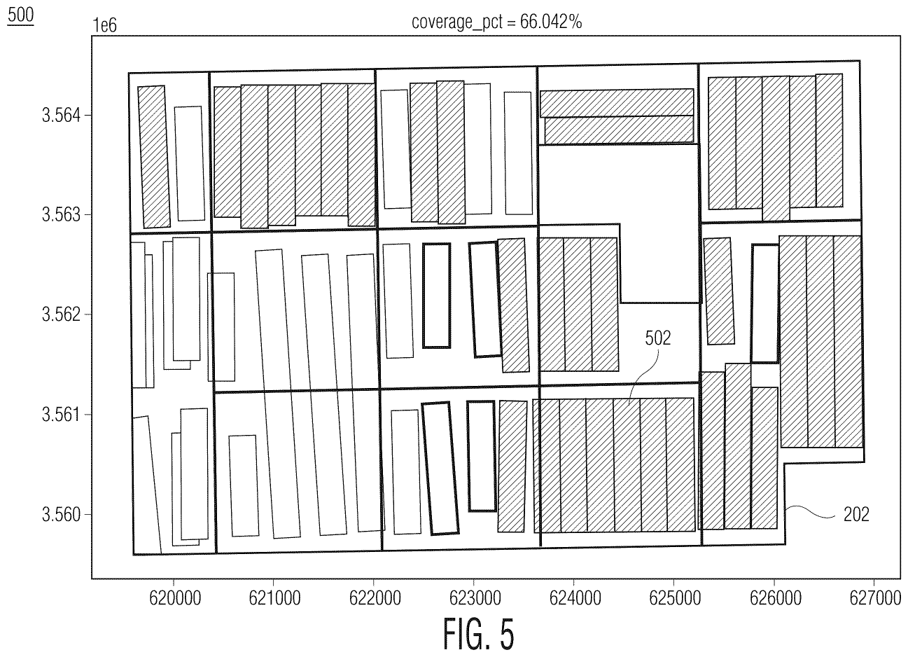

FIG. 5 is a schematic representation 500 of geographical area 202, according to example embodiments. As shown, geographical area 202 is filled with a plurality of new wells 502. Such representation 500 may represent a completed well placement process.

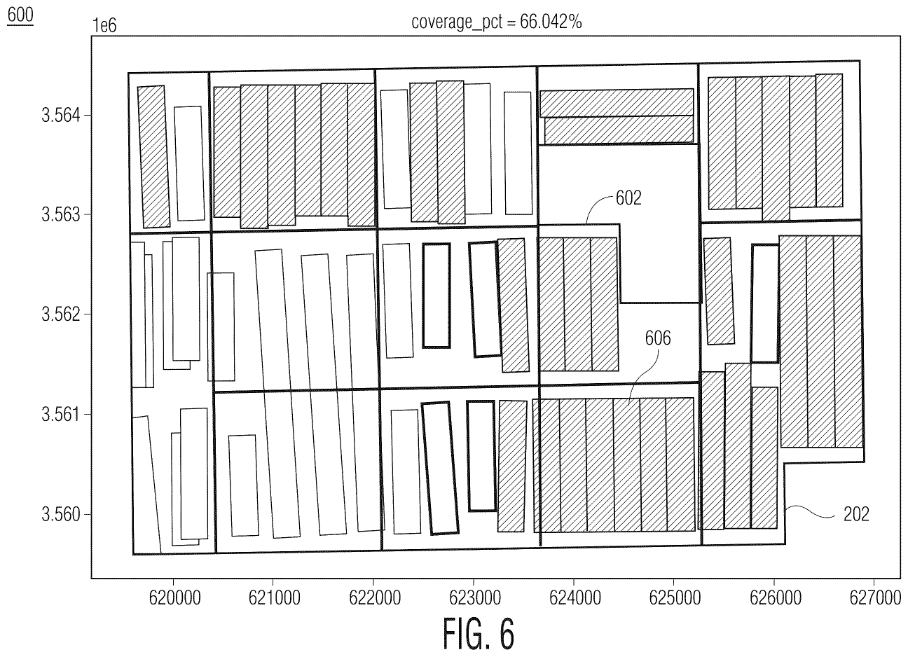

FIG. 6 is a schematic representation 600 of geographical area 202, according to example embodiments. Schematic representation 600 is substantially similar to schematic representation 500. However, schematic representation 600 illustrates an embodiment in which new wells 606 are placed in accordance with DSUs 602.

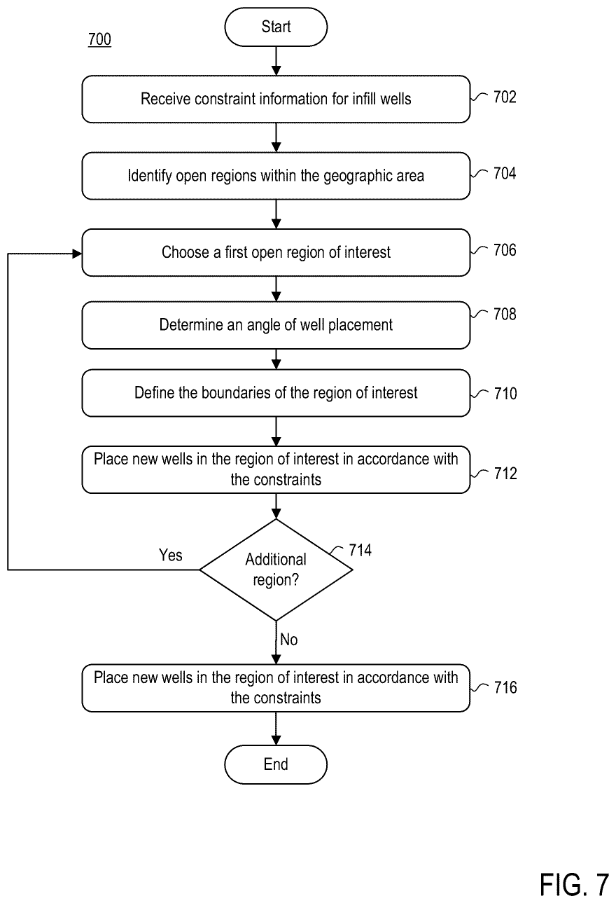

FIG. 7 is a flow diagram illustrating a method 700 for placing wells in a geographic area, according to example embodiments. Method 700 may begin at step 702.

At step 702, server system 104 may receive constrain information for infill wells. For example, lateral well placement system 116 may receive information related to a geographic area of interest (e.g., latitude/longitude values) and constraints for infill wells. In some embodiments, exemplary constraints may include, but are not limited to, a minimum size of each well, a maximum size of each well, and spacing parameters of the wells.

At step 704, server system 104 may identify open regions within the geographic area for placement of infill wells. For example, nuclei module 120 may identify open regions in the geographic area of interest for infill wells. In some embodiments, nuclei module 120 may identify open regions within a geographic area through a triangularization process, in which a plurality of nuclei or points in the geographic area are identified. In some embodiments, nuclei module 120 may employ a Delauney triangularization algorithm to generate a plurality of triangles in the geographic area. For example, nuclei module 120 may identify a plurality of vertices in the geographic area. The plurality of vertices in the geographic area may be based on existing wells or geometric objects in the geographic area. Nuclei module 120 may then use these vertices to create a plurality of triangles using a triangularization algorithm. From these triangles, nuclei module 120 may then take the midpoint of each side of each triangle. These midpoints may then represent the nuclei or points for further analysis.

At step 706, server system 104 may choose a first open region of interest. For example, nuclei module 120 may rank the plurality of nuclei identified in step 704 based on the distance of each nucleus to the nearest geometric object or existing well. In some embodiments, nuclei module 120 may take the Euclidean distance between each nucleus and the nearest geometric object. Nuclei module 120 may rank each nucleus, with the highest-ranking nuclei representing that nucleus having the greatest distance from any geometric object or existing well in the geographic area. Nuclei module 120 may select the highest ranked nuclei as the first nucleus for analysis. The region that includes the highest ranked nuclei may be the first open region of interest.

At step 708, server system 104 may determine an angle of well placement in the selected region of interest. For example, well angle module 122 may determine an angle at which a new well will be placed. In some embodiments, well angle module 122 may determine the angle at which the place a new well in order to match the angle of the new well to existing wells in a geographic region surrounding the selected nucleus. In some embodiments, well angle module 122 may identify an angle of existing wells in the geographic region surrounding the selected nucleus by taking a minimum rotated rectangle of geographic objects or existing wells in a region including the selected nucleus. Once the rectangle is generated, well angle module 122 may determine the angle of placement by taking the angle of the longer side of the rectangle.

At step 710, server system 104 may define the boundaries of the region of interest. For example, well placement module 124 may define the boundaries of the region of interest by placing a minimum length well at the selected nucleus at the determined angle. In some embodiments, the minimum length may be defined by the user or operator. Once the well is placed, well placement module 124 may then buffer out the well based on spacing constraints defined by the user. Once the minimum length, minimum spaced well is generated and placed, well placement module 124 may build out a region surrounding the minimum length, minimum spaced well for the inclusion of multiple wells. For example, well placement module 124 may expand the minimum length, minimum spaced well width wise until the spacing parameters are violated by any existing wells or other geographic object. In some embodiments this may be done by expanding the minimum length, minimum spaced well in a direction perpendicular to the placement angle. Following expansion in the width direction, well placement module 124 may then expand a length of the minimum length, minimum spaced well. In some embodiments, this may be done by expanding the now expanded minimum length, minimum spaced well in a direction parallel with the placement angle. This process may define the boundaries of the region of interest.

At step 712, server system 104 may place new wells in the region of interest in accordance with the constraints. For example, once the boundaries of the region of interest are defined, well placement module 124 may determine a number of wells that can be placed in the region in accordance with the constraints defined by the user or operator. Well placement module 124 may place or propose wells for inclusion in the region of interest based on the determined number of wells. In some embodiments, well placement module 124 may place new wells in the region of interest by placing as many minimum length wells in the region of interest in accordance with the spacing parameters. Well placement module 124 may then try to extend each new placed well, individually, to twice the maximum lateral length. If, for example, well placement module 124 determines that a placed well hits or interferes with another placed buffered well, existing buffered well, or DSU boundary, then well placement module 124 may stop extending that individual well at that point. In some embodiments, well placement module 124 may split the placed wells to respect the minimum and maximum length constraints specified in the user requests. In some embodiments, well placement module 124 may prioritize creating maximum-length wells when possible. For example, if well placement module 124 determines that there is 14,000 feet available length for one well, with a 3000 foot minimum and 10,000 foot max requested length, well placement module 124 may place a 10,000 foot well and a 4000 foot well.

At step 714, server system 104 may determine whether there are additional regions to analyze. For example, once the wells are placed in the region, method 700 may revert to step 704 and lateral well placement system 116 may identify a next region of interest by identifying a next highest ranked nucleus. In some embodiments, nuclei module 120 may identify the next highest ranked nucleus by removing from the list all nuclei that were included in the region filled by wells by well placement module 124. If, for example, at step 714, server system 104 determines that there are still nuclei left to analyze, then method 700 may revert to step 704. If, however, at step 714, server system 104 determines that there are no further nuclei to analyze, then method 700 may proceed to step 716.

At step 716, server system 104 may generate a graphical representation of the geographic area of interest with the proposed new wells. For example, lateral well placement system 116 may generate, as output, a representation of the geographical area of interest, such as that shown and described above in conjunction with FIG. 5.

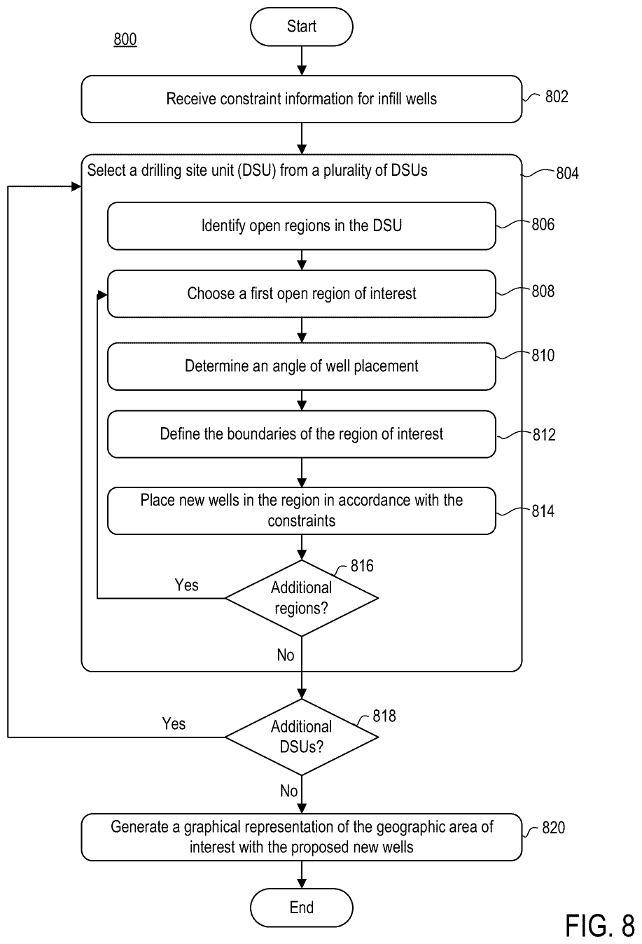

FIG. 8 is a flow diagram illustrating a method 800 for placing wells in a geographic area, according to example embodiments. Method 800 may begin at step 802.

At step 802, server system 104 may receive constrain information for infill wells. For example, lateral well placement system 116 may receive information related to a geographic area of interest (e.g., latitude/longitude values) and constraints for infill wells. In some embodiments, exemplary constraints may include, but are not limited to, a minimum size of each well, a maximum size of each well, and spacing parameters of the wells. In some embodiments, the geographic area of interest may include a plurality of DSUs. For example, upon receiving information related to the geographic area of interest, lateral well placement system 116 may interface with data store 106 to retrieve information regarding the geographic area of interest. Such information may include existing well information, DSU information, and geographic parameters.

At step 804, server system 104 may select a first DSU from the plurality of DSUs for analysis. Step 804 may include sub-steps 806-816.

At sub-step 806, server system 104 may identify open regions within the DSU for placement of infill wells. For example, nuclei module 120 may identify open regions in the first DSU for infill wells. In some embodiments, nuclei module 120 may identify open regions within the first DSU through a triangularization process, in which a plurality of nuclei or points in the first DSU are identified. In some embodiments, nuclei module 120 may employ a Delauney triangularization algorithm to generate a plurality of triangles in the geographic area. For example, nuclei module 120 may identify a plurality of vertices in the first DSU. The plurality of vertices in the first DSU may be based on existing wells or geometric objects in the first DSU. Nuclei module 120 may then use these vertices to create a plurality of triangles using a triangularization algorithm. From these triangles, nuclei module 120 may then take the midpoint of each side of each triangle. These midpoints may then represent the nuclei or points for further analysis.

At sub-step 808, server system 104 may choose a first open region of interest in the first DSU. For example, nuclei module 120 may rank the plurality of nuclei identified in step 804 based on the distance of each nucleus to the nearest geometric object or existing well in the first DSU. In some embodiments, nuclei module 120 may take the Euclidean distance between each nucleus and the nearest geometric object in the first DSU. Nuclei module 120 may rank each nucleus, with the highest-ranking nuclei representing that nucleus having the greatest distance from any geometric object or existing well in the first DSU. Nuclei module 120 may select the highest ranked nuclei as the first nucleus for analysis. The region that includes the highest ranked nuclei may be the first open region of interest.

At sub-step 810, server system 104 may determine an angle of well placement in the selected region of interest. For example, well angle module 122 may determine the angle of placement by taking a minimum rotated rectangle of the DSU. For example, well angle module 122 may generate a minimum rotated rectangle that fits the boundaries of the first DSU. Once the rectangle is generated, well angle module 122 may determine the angle of placement by taking the angle of the longer side of the rectangle.

At sub-step 812, server system 104 may define the boundaries of the region of interest. For example, well placement module 124 may define the boundaries of the region of interest by placing a minimum length well at the selected nucleus at the determined angle. In some embodiments, the minimum length may be defined by the user or operator. Once the well is placed, well placement module 124 may then buffer out the well based on spacing constraints defined by the user. Once the minimum length, minimum spaced well is generated and placed, well placement module 124 may build out a region surrounding the minimum length, minimum spaced well for the inclusion of multiple wells. For example, well placement module 124 may expand the minimum length, minimum spaced well width wise until the spacing parameters are violated by any existing wells or other geographic object. In some embodiments this may be done by expanding the minimum length, minimum spaced well in a direction perpendicular to the placement angle. Following expansion in the width direction, well placement module 124 may then expand a length of the minimum length, minimum spaced well. In some embodiments, this may be done by expanding the now expanded minimum length, minimum spaced well in a direction parallel with the placement angle. This process may define the boundaries of the region of interest within the first DSU.

At sub-step 814, server system 104 may place new wells in the region of interest in accordance with the constraints. For example, once the boundaries of the region of interest are, well placement module 124 may determine a number of wells that can be placed in the region in accordance with the constraints defined by the user or operator. Well placement module 124 may place or propose wells for inclusion in the region of interest based on the determined number of wells.

At sub-step 816, server system 104 may determine whether there are additional regions to analyze. For example, once the wells are placed in the region, method 800 may revert to sub-step 808 and lateral well placement system 116 may identify a next region of interest by identifying a next highest ranked nucleus in the first DSU. In some embodiments, nuclei module 120 may identify the next highest ranked nucleus by removing from the list all nuclei that were included in the region filled by wells by well placement module 124. If, for example, at sub-step 816, server system 104 determines that there are still nuclei left to analyze in the first DSU, then method 800 may revert to sub-step 808. If, however, at sub-step 816, server system 104 determines that there are no further nuclei to analyze, then method 800 may proceed to step 818.

At step 818, server system 104 may determine whether there are additional DSUs from the plurality of DSUs to analyze. If, at step 818, server system 104 determines that there are additional DSUs to analyze, then method 800 may revert to step 804, and a next DSU is selected for analysis. If, however, at step 818, server system 104 determines that there are no additional DSUs to analyze, then method 800 may proceed to step 820.

At step 820, server system 104 may generate a graphical representation of the geographic area of interest with the proposed new wells. For example, lateral well placement system 116 may generate, as output, a representation of the geographical area of interest, such as that shown and described above in conjunction with FIG. 6.

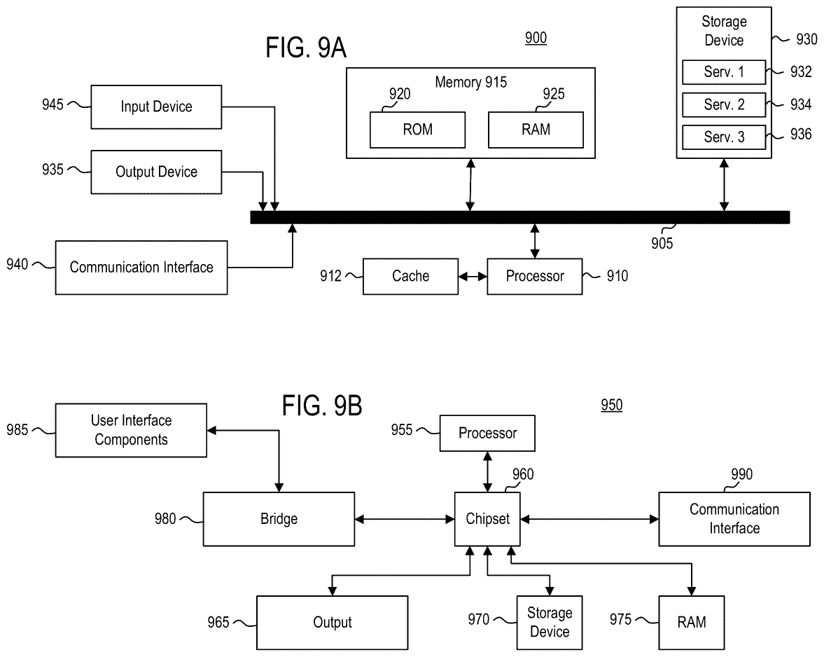

FIG. 9A illustrates a system bus architecture of computing system 900, according to example embodiments. System 900 may be representative of at least user device 102 or server system 104. One or more components of system 900 may be in electrical communication with each other using a bus 905. System 900 may include a processing unit (CPU or processor) 910 and a system bus 905 that couples various system components including the system memory 915, such as read only memory (ROM) 920 and random-access memory (RAM) 925, to processor 910.

System 900 may include a cache of high-speed memory connected directly with, in close proximity to, or integrated as part of processor 910. System 900 may copy data from memory 915 and/or storage device 930 to cache 912 for quick access by processor 910. In this way, cache 912 may provide a performance boost that avoids processor 910 delays while waiting for data. These and other modules may control or be configured to control processor 910 to perform various actions. Other system memory 915 may be available for use as well. Memory 915 may include multiple different types of memory with different performance characteristics. Processor 910 may include any general-purpose processor and a hardware module or software module, such as service 1 932, service 2 934, and service 3 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction with the computing system 900, an input device 945 may represent any number of input mechanisms, such as a microphone for speech, a touch-sensitive screen for gesture or graphical input, keyboard, mouse, motion input, speech and so forth. An output device 935 may also be one or more of a number of output mechanisms known to those of skill in the art. In some instances, multimodal systems may enable a user to provide multiple types of input to communicate with computing system 900. Communications interface 940 may generally govern and manage the user input and system output. There is no restriction on operating on any particular hardware arrangement and therefore the basic features here may easily be substituted for improved hardware or firmware arrangements as they are developed.

Storage device 930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 925, read only memory (ROM) 920, and hybrids thereof.

Storage device 930 may include services 932, 934, and 936 for controlling the processor 910. Other hardware or software modules are contemplated. Storage device 930 may be connected to system bus 905. In one aspect, a hardware module that performs a particular function may include the software component stored in a computer-readable medium in connection with the necessary hardware components, such as processor 910, bus 905, output device 935 (e.g., display), and so forth, to carry out the function.

FIG. 9B illustrates a computer system 950 having a chipset architecture that may represent user device 102 or server system 104. Computer system 950 may be an example of computer hardware, software, and firmware that may be used to implement the disclosed technology. System 950 may include a processor 955, representative of any number of physically and/or logically distinct resources capable of executing software, firmware, and hardware configured to perform identified computations. Processor 955 may communicate with a chipset 960 that may control input to and output from processor 955.

In this example, chipset 960 outputs information to output 965, such as a display, and may read and write information to storage device 970, which may include magnetic media, and solid-state media, for example. Chipset 960 may also read data from and write data to storage device 975 (e.g., RAM). A bridge 980 for interfacing with a variety of user interface components 985 may be provided for interfacing with chipset 960. Such user interface components 985 may include a keyboard, a microphone, touch detection and processing circuitry, a pointing device, such as a mouse, and so on. In general, inputs to system 950 may come from any of a variety of sources, machine generated and/or human generated.

Chipset 960 may also interface with one or more communication interfaces 990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 955 analyzing data stored in storage device 970 or storage device 975. Further, the machine may receive inputs from a user through user interface components 985 and execute appropriate functions, such as browsing functions by interpreting these inputs using processor 955.

It may be appreciated that example systems 900 and 950 may have more than one processor 910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method of placing infill wells in a geographic area comprising pre-existing wells, the method comprising:
receiving, by a computing system, a request to place new wells in a geographic area comprising pre-existing wells, the request comprising constraints for the new wells, the constraints comprising size information of the new wells and spacing information for the new wells;
identifying, by the computing system, an open region in the geographic area for placement of the new wells;
determining, by the computing system, an angle at which to place the new wells in the open region based on a subset of the pre-existing wells in the open region;
defining, by the computing system, boundaries of the open region for placement of the new wells;
placing, by the computing system, at least one new well within the boundaries of the open region in accordance with the constraints; and
generating, by the computing system, a graphical representation of the geographic area with the pre-existing wells and the at least one new well in the boundaries of the open region.

2. The method of claim 1, wherein identifying, by the computing system, the open region in the geographic area for placement of the new wells comprises:
identifying a plurality of vertices in the geographic area, the plurality of vertices corresponding to at least the pre-existing wells;
generating, using a triangularization algorithm, a plurality of triangles in the geographic area using the plurality of vertices; and
generating a plurality of nuclei based on the plurality of triangles.

3. The method of claim 2, further comprising:
generating a distance between each nucleus and the pre-existing wells;
ranking the plurality of nuclei based on each nucleus'distance from the pre-existing wells; and
selecting a top ranked nucleus of the plurality of nuclei for the open region.

4. The method of claim 1, wherein determining, by the computing system, the angle at which to place the new wells in the open region based on the subset of the pre-existing wells in the open region comprises:
matching angles of the subset of the pre-existing wells by taking a minimum rotated rectangle of the subset of the pre-existing wells in the open region.

5. The method of claim 1, wherein defining, by the computing system, the boundaries of the open region for placement of the new wells comprises:
placing a minimum length well within the open region in accordance with the size information in the constraints;
buffering out a size of the minimum length well based on the spacing information in the constraints;
extending the minimum length well in a width direction until a geometric object or pre-existing well is identified; and
extending the minimum length well in a length direction until a geometric object or pre-existing well is identified.

6. The method of claim 1, further comprising:
determining, by the computing system, additional new wells for placement in the open region, wherein the additional new wells are placed perpendicular to the determined angle.

7. The method of claim 1, wherein the geographic area is a drilling spacing unit.

8. A non-transitory computer readable medium comprising one or more sequences of instructions, which, when executed by a processor, causes a computing system to perform operations comprising:
receiving, by a computing system, a request to place new wells in a geographic area comprising pre-existing wells, the request comprising constraints for the new wells, the constraints comprising size information of the new wells and spacing information for the new wells;
identifying, by the computing system, an open region in the geographic area for placement of the new wells;
determining, by the computing system, an angle at which to place the new wells in the open region based on a subset of the pre-existing wells in the open region;
defining, by the computing system, boundaries of the open region for placement of the new wells;
placing, by the computing system, at least one new well within the boundaries of the open region in accordance with the constraints; and
generating, by the computing system, a graphical representation of the geographic area with the pre-existing wells and the at least one new well in the boundaries of the open region.

9. The non-transitory computer readable medium of claim 8, wherein identifying, by the computing system, the open region in the geographic area for placement of the new wells comprises:
identifying a plurality of vertices in the geographic area, the plurality of vertices corresponding to at least the pre-existing wells;
generating, using a triangularization algorithm, a plurality of triangles in the geographic area using the plurality of vertices; and
generating a plurality of nuclei based on the plurality of triangles.

10. The non-transitory computer readable medium of claim 9, further comprising:
generating a distance between each nucleus and the pre-existing wells;
ranking the plurality of nuclei based on each nucleus' distance from the pre-existing wells; and
selecting a top ranked nucleus of the plurality of nuclei for the open region.

11. The non-transitory computer readable medium of claim 8, wherein determining, by the computing system, the angle at which to place the new wells in the open region based on the subset of the pre-existing wells in the open region comprises:
matching angles of the subset of the pre-existing wells by taking a minimum rotated rectangle of the subset of the pre-existing wells in the open region.

12. The non-transitory computer readable medium of claim 8, wherein defining, by the computing system, the boundaries of the open region for placement of the new wells comprises:
placing a minimum length well within the open region in accordance with the size information in the constraints;
buffering out a size of the minimum length well based on the spacing information in the constraints;
extending the minimum length well in a width direction until a geometric object or pre-existing well is identified; and
extending the minimum length well in a length direction until a geometric object or pre-existing well is identified.

13. The non-transitory computer readable medium of claim 8, further comprising:
determining, by the computing system, additional new wells for placement in the open region, wherein the additional new wells are placed perpendicular to the determined angle.

14. The non-transitory computer readable medium of claim 8, wherein the geographic area is a drilling spacing unit.

15. A system, comprising:
a processor; and
a memory having programming instructions stored thereon, which, when executed by the processor, causes the system to perform operations comprising:
receiving a request to place new wells in a geographic area comprising pre-existing wells, the request comprising constraints for the new wells, the constraints comprising size information of the new wells and spacing information for the new wells;
identifying an open region in the geographic area for placement of the new wells;
determining an angle at which to place the new wells in the open region based on a subset of the pre-existing wells in the open region;
defining boundaries of the open region for placement of the new wells;
placing at least one new well within the boundaries of the open region in accordance with the constraints; and
generating a graphical representation of the geographic area with the pre-existing wells and the at least one new well in the boundaries of the open region.

16. The system of claim 15, wherein identifying the open region in the geographic area for placement of the new wells comprises:
identifying a plurality of vertices in the geographic area, the plurality of vertices corresponding to at least the pre-existing wells;
generating, using a triangularization algorithm, a plurality of triangles in the geographic area using the plurality of vertices; and
generating a plurality of nuclei based on the plurality of triangles.

17. The system of claim 16, further comprising:
generating a distance between each nucleus and the pre-existing wells;
ranking the plurality of nuclei based on each nucleus' distance from the pre-existing wells; and
selecting a top ranked nucleus of the plurality of nuclei for the open region.

18. The system of claim 15, wherein determining the angle at which to place the new wells in the open region based on the subset of the pre-existing wells in the open region comprises:
matching angles of the subset of the pre-existing wells by taking a minimum rotated rectangle of the subset of the pre-existing wells in the open region.

19. The system of claim 15, wherein defining the boundaries of the open region for placement of the new wells comprises:
placing a minimum length well within the open region in accordance with the size information in the constraints;
buffering out a size of the minimum length well based on the spacing information in the constraints;
extending the minimum length well in a width direction until a geometric object or pre-existing well is identified; and
extending the minimum length well in a length direction until a geometric object or pre-existing well is identified.

20. The system of claim 15, wherein the geographic area is a drilling spacing unit.
